(19) United States
(12) Patent Application Publication
(10) Pub. No.: US 2019/0318523 A1
(43) Pub. Date: Oct. 17, 2019

(54) Methods and Systems for Monitoring User Activity and Managing Controllers in 3-D Graphics

(71) Applicant: Zhuhai Kingsoft Online Game Technology Co., Ltd., Zhuhai City (CN)

(72) Inventor: Sean Higginbottom, San Francisco, CA (US)

(21) Appl. No.: 15/954,240

(22) Filed: Apr. 16, 2018

(51) Int. Cl. G06T 13/40

(52) U.S. Cl. CPC G06T 13/40

(57) ABSTRACT

Embodiments of the present invention include computer-implemented methods and apparatuses for monitoring user activity and managing controllers in a 3-D environment that are provided herein. Exemplary methods may include: receiving user input in the form of user activity associated with a rigging of a character in a 3-D environment; monitoring the user activity, the user activity being indicated by a change in animation curve data; detecting a change in the user activity; identifying nodes associated with the change in the user activity, in which the nodes are controllers that are manipulated by the user in the rigging of a character in a 3-D environment; and adjusting the nodes such that the nodes are matched to the change in the user activity.

### FIELD OF THE INVENTION

The present technology relates generally to interactive three-dimensional (3-D) computer graphics, and more specifically, to monitoring user activity and managing controllers in 3-D computer environments.

### SUMMARY OF THE INVENTION

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Embodiments of the present invention include computer-implemented methods and apparatuses for monitoring user activity and managing controllers in a 3-D environment that are provided herein. Exemplary methods may include: receiving user input in the form of user activity associated with a rigging of a character in a 3-D environment; monitoring the user activity, the user activity being indicated by a change in animation curve data; detecting a change in the user activity; identifying nodes associated with the change in the user activity, in which the nodes are controllers that are manipulated by the user in the rigging of a character in a 3-D environment; and adjusting the nodes such that the nodes are matched to the change in the user activity.

In various embodiments, a system may include a processor; and a memory coupled to the processor, the memory storing instructions executable by the processor to perform a method for monitoring user activity and managing controllers in a 3-D environment, the method comprising: monitoring user activity associated with a rigging of a character in a 3-D environment, the user activity being indicated by a change in animation curve data; detecting a change in the user activity; identifying nodes associated with the change in the user activity in which the nodes are controllers that are manipulated by a user in the rigging of a character in a 3D environment; and adjusting the nodes such that the nodes are matched to the change in the user activity.

In other embodiments, a non-transitory computer-readable storage medium having stored thereon computer-executable instructions that, in response to execution by a processor, performs a computer-implemented method for monitoring user activity and managing controllers in a 3-D environment, the method including: receiving user input in the form of user activity associated with a rigging of a character in a 3-D environment; monitoring the user activity, the user activity being indicated by a change in animation curve data; detecting a change in the user activity; identifying nodes associated with the change in the user activity, in which the nodes are controllers that are manipulated by the user in the rigging of a character in a 3-D environment; and adjusting the nodes such that the nodes are matched to the change in the user activity.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments. The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an example system architecture for practicing aspects of the present disclosure.

FIG. 2 is a flowchart of an example method for monitoring user activity and managing controllers in a 3-D computer environment, according to embodiments of the present disclosure.

FIG. 3 is a rendering of the rigging of a character in a 3-D computer environment.

FIG. 4 is a schematic diagram of an example computer device that can be utilized to implement aspects of the present disclosure.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

The embodiments described herein provide improvements to the experience of a user in character rigging, including setting a selected controller to a kinematic mode that matches the kinematic mode of a currently used tool and applying the kinematic mode that matches the kinematic mode of a currently used tool to controller(s) related to the selected controller; applying a position of a selected controller to controller(s) related to the selected controller; applying a mode of a selected controller to controller(s) related to the selected controller; distinguishing keys associated with one controller from keys associated with another controller, and allowing a controller set in an unused mode to be visible but unable to be selected by the user until the user switches to the mode of the controller.

The embodiments described herein eliminate an abrupt change that may be caused by the switch between inverse kinematics (IK) and forward kinematics (FK) during the course of animation to position and/or pose an appendage of a character being animated. A user (i.e., an animator) generally needs to switch between FK and IK during the course of the animation to position and/or pose the appendage. However, because FK and IK define different locations and/or rotations for the same appendage joint, switching between the two kinematic modes may result in an abrupt change in the location and/or rotation of the joint that is visually unrealistic. For example, if a user were to animate a character jumping and grabbing a ledge, the user would use FK mode in animating the character jumping to the ledge. When the character reaches the ledge, the user would then switch to IK mode so that the hands of the character can be animated to grasp the ledge (or if the character has not yet reached the ledge, the hands of the character can be animated to attempt to reach the ledge). When switching from FK mode to IK mode, the IK controllers (i.e., the hand controller under IK mode) would be in their initial positions, rather than the positions in which the FK controllers (i.e., the hand controller under FK mode) were previously set, forcing the user to move the controllers manually. The embodiments described herein solve this problem by tracking the positions of all FK and IK controllers and updating the positions of the controllers in the inactive kinematic mode to match the positions of the controllers in the currently active kinematic mode. When the switch between the kinematic modes happens (i.e., from IK to FK, or FK to IK), the controllers in the newly active mode are in the same position as that of the controllers in the newly inactive mode, due to the updated position of the controllers in the newly inactive mode. As such, the blend between IK and FK positions, which may be jarring and/or unrealistic, is no longer a problem since both kinematic chains are constantly forced to be in the same position.

An embodiment of the claimed method is executed by a plurality of modules that can be implemented, for example, by means of instructions. In many cases, the user may be working with a 3-D computing environment, such as Autodesk® Maya, to manipulate a rig in a 3-D space.

Modern computer animation often represents a character in two parts: a surface representation that visually portrays the character and is typically a polygonal mesh often referred to as a “skin”, and a hierarchical set of interconnected members used to animate or pose the mesh. The hierarchical set of interconnected members is often referred to as a “controller”. The controller is a node that is manipulated by a user when the user is animating the character. For example, when the user wants to manipulate the arm of a human character, the user selects the shoulder controller. The manipulation of the shoulder controller governs the positioning of the human character's shoulder, which in turn governs the positioning of the human character's arm. The set of interconnected members may be referred to as a skeleton or rig. Rig animation is often used to animate human or animal characters, inanimate objects, machines, and/or the like. Rig animation can be used to control the deformation of any object (to be referred to interchangeably with “character” in this disclosure) within a 3-D scene. The set of techniques used to create a unified set of skeletal members for an object or character is often referred to as rigging a character.

In order for a user to make the character move and interact with its environment, the mesh may be bound to a system of control handles and joints that may be used to pose the 3-D model. The system of joints and control handles may be referred to as a rig. Conceptually, a rig may be thought of as a skeletal structure for a 3-D animated object. For example, a rig for a biped human character may visually and functionally resemble a human skeleton. Users may use control points attached to the skeletal rig to govern the movement of the character. The rigs can be coupled to points on the mesh, which can respond with fluid movements when the rig is moved. Rigs for less human objects in a 3-D scene may not correspond directly with a skeletal frame, but will often still provide control points that can be manipulated by a user as the scene progresses through time. By way of example, this disclosure may use character rigs that include essentially a digital skeleton coupled to a mesh. Like a real skeleton, the rig may be composed of joints, bones, and controls that act as “anchors” for users to manipulate the character into a desired pose.

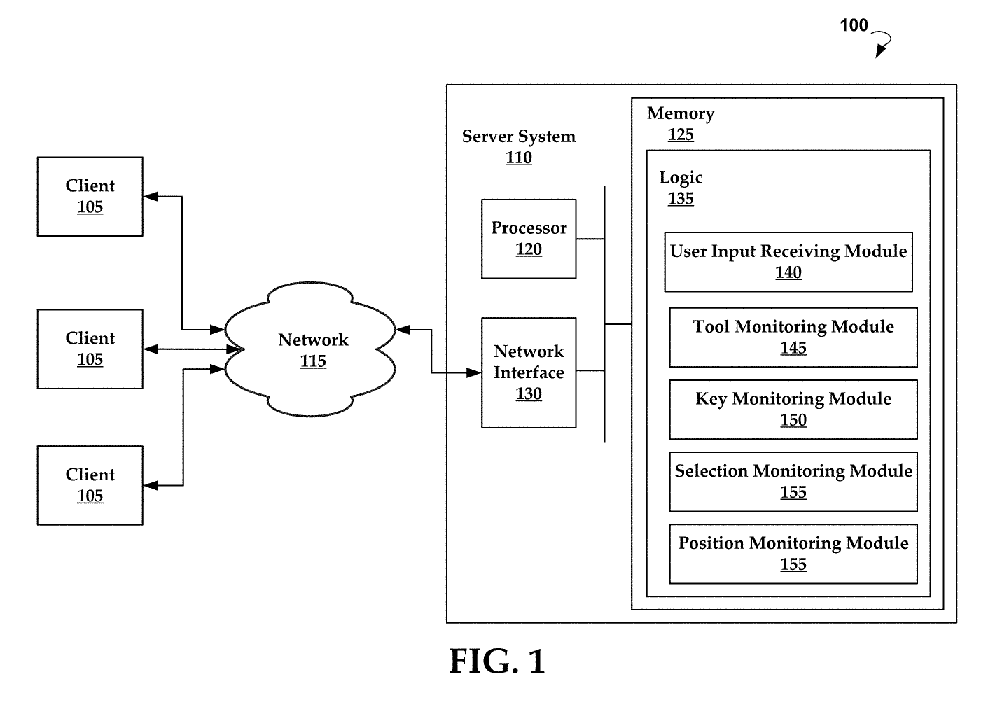

FIG. 1 illustrates an exemplary architecture for practicing aspects of the present disclosure. The architecture comprises one or more clients 105 communicatively coupled to a server system 110 via a public or private network, such as a network 115. In various embodiments, the client 105 includes at least one of a personal computer, a laptop, a Smartphone, or other suitable computing device.

Suitable networks for network 115 may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V6.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 115 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

Generally, the server system 110 is configured to provide various functionalities which are described in greater detail throughout the present disclosure. In various embodiments, the server system 110 comprises a processor 120, a memory 125, and a network interface 130. According to some embodiments, the memory 125 comprises logic 135 (otherwise referred to as instructions) that may be executed by the processor 120 to perform various methods described herein. For example, the logic 135 may include a user input receiving module 140, a tool monitoring module 145, a key monitoring module 150, a selection monitoring module 155, and a position monitoring module 160, which are configured to provide some or all of the functionalities described in greater detail herein. It is to be understood that, while the methods described herein are generally attributed to the server system 110, the methods described herein may also be executed by the client 105. In other embodiments, the server system 110 and the client 105 may cooperate to provide the functionalities described herein. The client 105 may be provided with a client-side application that interacts with the server system 110 in a client/server relationship.

In general, the user input receiving module 140 may receive user input, for example, in the form of user activity in the rigging of a character, from the client 105. The receipt of user input by the user input receiving module 140 may activate the plurality of monitoring modules to monitor the user activity in the rigging of a character.

Animation of a 3-D object may involve the use of a 3-D authoring tool to specify a sequence of keys for each of a number of attributes of an object that the user wants to manipulate. Keys (also known as “key frames”) are arbitrary markers that specify the property values of an object at a particular time. These attributes and their associated sequences are often referred to as animation channels and might correspond to characteristics such as movement along a particular axis (i.e., translation in one or more dimensions), rotation in one or more dimensions, scale or size, shape, color, and the like. Each key in a given animation channel specifies an attribute value at a given point in time as well as a tangent setting that specifies a curvature leading to or leaving that key. Thus, the collection of keys specifies an animation curve for that channel. The animation curve represents how the value of the object attribute for that channel changes over time. For example, for a translation attribute, an animation curve might represent locations of an object along an axis in a virtual space over time. In another example relating to a color attribute, an animation curve might represent color, brightness, and/or shading values of an object over time.

Any change to the data in an animation curve is indicative of the user activity that is monitored by the plurality of monitoring modules. Each of the monitoring modules is responsible for monitoring a particular activity of the user in the rigging of a character. Each particular activity of the user in the rigging of a character is known as an event. For example, the monitoring modules may include the tool monitoring module 145, the key monitoring module 150, the selection monitoring module 155, the position monitoring module 160, and the like, and each of these monitoring modules is responsible for monitoring a specific event.

A variety of tools may be made available by the 3-D computing environment for the user in rigging a character. Such tools include allowing a user to: select an object, or a component of an object, to manipulate; “lasso” an object, or a component of an object, in a view panel by drawing a freeform shape around the object, or the component of an object; paint over components, such as vertices or faces, of an object; move an object or a component of an object; rotate an object or a component of an object; scale an object or a component of an object (i.e., enlarge or shrink the object or the component of an object by a scale factor that is the same in all directions); and the like.

The tool monitoring module 145 may check for the utilization of a tool by the user. When the tool monitoring module 145 determines that a tool is being used, the tool monitoring module 145 may ascertain the identity of the tool that is currently utilized by the user, as well as the identity of the tool (if any) that was used by the user just prior to the utilization of the current tool.

The tool monitoring module 145 may determine the identity of the controller that is currently selected by the user. In order to determine the controller that is currently selected by the user, the tool monitoring module 145 may check for a controller that is named based on a rigging name convention. For instance, the rigging name convention may be set as follows: c_sideOfBody_name_versionNumber_type. Using this example, if a character has four arms (with two arms on each side), the selected elbow controller on the lower arm of the right side would be named “c_R_elbow_v2_CTRL,” per the rigging name convention. The “v2” stands for “version 2,” which is to be understood as the second limb of the right side, and “CTRL” would stand for “controller.” As mentioned earlier, the controller may be a node. The tool monitoring module 145 may then ascertain if a current kinematic mode (inverse kinematic mode (IK mode) or forward kinematic mode (FK mode)) of the selected controller needs to be changed based on the current tool being utilized.

If the determination is made that the current kinematic mode needs to be changed based on the current tool, then the tool monitoring module 145 may set the selected controller to a new kinematic mode that is appropriate given the current tool. If such a determination is not made, the current kinematic mode of the selected controller may remain unchanged.

The tool monitoring module 145 may then find the controllers related to the selected controller and loop through all the related controllers that are found. The selected controller has a string attribute that has been placed by the user either manually or automatically through a script. The controllers related to the selected controller have this string attribute as well. The tool monitoring module 145 finds the controllers related to the selected controller by searching the controllers for this string attribute that was placed on the selected controller. If a new kinematic mode is provided to the selected controller, the found related controllers may then be set to the new kinematic mode. Kinematics, as well as kinematic modes, are described in further detail below.

The movement of the 3-D character, such as a human body, is typically specified by kinematics. An appendage object (e.g., an arm, a leg, a tail, a foot, a hand) can be particularly challenging to create realistic positions and/or poses because the appendage's joints have several degrees of freedom to manipulate. Kinematics controls the movement of various parts of an articulated object in terms of joint parameters. As a result, users have generally applied forward and inverse kinematics to model and create the appendage's movements.

Forward kinematics (FK) uses joint parameters to compute the shape of a resulting configuration of an object. For example, forward kinematics uses the joint parameters of an elbow to compute the resulting shape of an arm. Further, FK can define what the exact location and/or rotation of each appendage joint should be. FK can generally be used to set a particular pose of the appendage.

Inverse kinematics (IK), in reverse, uses a resulting or desired shape of an object to compute joint parameters. For example, inverse kinematics uses the desired position of a hand to compute the joint parameters of an elbow that would provide that desired hand position. Further, IK can define a goal or destination of the appendage (e.g., the appendage should touch another object), and then calculate the location and/or rotation required for each appendage joint to reach that goal or destination. IK can generally be used to set a particular goal for the appendage.

With FK, individual joints are moved and rotated to pose and animate joint chains. Moving a joint affects that joint and any joints below it in the hierarchy. For example, if a joint chain to reach for a particular location in space is desired, each joint needs to be rotated individually so that the joint chain can reach that location. To do this, the joint chain's parent joint is rotated and translated, the next joint is then rotated and translated, and so on, down the joint chain. When a skeleton is animated using FK, the joint rotations starting with the root joint are interpolated, the child joints of the root joint are then interpolated, and so on, down through the hierarchy of the skeleton.

Both a forward kinematics mode (FK mode) and an inverse kinematics mode (IK mode) may be available in a 3-D computer graphics software environment to be selected for use in animation by a user.

When a user, having selected FK mode, wants to move a hand to touch a wall, the user selects the shoulder controller and rotates the shoulder controller in the direction of the wall, which in turn moves the elbow and the hand. In FK mode, the elbow controller can be rotated for the purpose of a more convincing pose. Moving the elbow controller moves the hand but not the shoulder, as the shoulder is above the elbow in the hierarchy of the skeleton.

With IK, an inverse kinematic handle (IK handle) is moved to pose an entire joint chain. An IK handle is an object which can be selected and moved, and it affects the joints to which it is assigned. A joint chain that has an IK handle is called an IK chain. When a joint chain with an IK handle is posed and animated, an IK solver automatically rotates all the joints in the IK chain. The IK solver is what is used to calculate the rotations of all the joints in the IK chain when the IK handle is positioned.

When a user, having selected IK mode, wants to move a hand to touch a wall, the user selects the hand controller (located at the end of the arm segment of the 3-D human character) to the wall. In the process, the segments above the hand (the elbow and the shoulder) bends/rotates to assist the hand controller in meeting the wall.

In a non-limiting example of the tool monitoring module 145, a user may use a tool provided by the 3-D computing environment to move a hand to touch a wall. In an example, the “rotate” tool may be used by the user. The tool monitoring module 145 may determine that a tool is currently being used, and that the identity of this tool is the “rotate” tool.

The tool monitoring module 145 may then check to see if there was a tool that was used prior to the utilization of the “move” tool. The tool monitoring module 145 may check for a prior tool, because a change from IK mode to FK mode (or FK mode to IK mode) may be unnecessary based on the kinematic modes of the prior tool (here, the “move” tool) and the current tool (here, the “rotate” tool) if the prior tool and the current tool share the same kinematic mode. A change from IK mode to FK mode (or FK mode to IK mode) may be necessary if the kinematic modes of the prior tool and the current tool, respectively, are different. The “move” tool can perform IK behavior (i.e., translate an object) and as such, may be in IK mode. The tool used prior to the “move” tool may have been the “rotate” tool. The “rotate” tool can perform FK behavior (i.e., change the orientation of an object) and as such, may be in FK mode. In this example, the shoulder controller has been selected by the user. The tool monitoring module 145 may then determine that the shoulder controller is the selected controller, and that the current kinematic mode of the selected controller is IK. Based on the “move” tool that was previously used and the “rotate” tool that is currently used, the tool monitoring module 145 may determine that the selected controller would need to be set from IK mode to FK mode.

The tool monitoring module 145 may then find the controllers related to the shoulder controller (e.g., the elbow controller and the hand controller) and loops through the related controllers. The shoulder controller has a string attribute that has been placed by the user either manually or automatically through a script. The controllers related to the shoulder controller have this string attribute as well. The tool monitoring module 145 finds the controllers related to the shoulder controller by searching the controllers for this string attribute that was placed on the shoulder controller. Here, the related controllers that are found are the elbow controller and the hand controller. The elbow controller and the hand controller may then be set to FK mode.

Keys are arbitrary markers that specify the property values of an object at a particular time. Setting keys is the process of creating the markers that specify timing and action in animation. Animation is the process of creating and editing the properties of objects that change over time, and this creating and editing is done by the user via keys. Once a user creates an object that is to be animated, the user sets keys that represent the attributes of that object changing during animation.

Setting a key involves the user moving a key to a position (at a time) on an animation timeline where the user wants to establish a value for an attribute, setting that value, and then placing a key at that particular time on the animation timeline. In effect, the user is recording a snapshot of the attribute at that time. The timeline displays keys of an object that has been selected. If the object is deselected, the keys disappear from the timeline until the user reselects the object. Conversely, if the user has selected more than one animated object, the keys of all the combined objects are displayed on the timeline.

The user can rearrange, remove, and duplicate keys and sequences of keys. For example, the user can copy the animated properties of one object onto another, or the user can stretch a chunk of animation over a longer period of time than what was originally keyed.

Characters and objects designed for 3-D computer animations may be constructed using a number of different elements. For example, a 3-D character model may include a mesh that defines an outer surface of the character. The mesh may be linked with surface characteristics, such as textures, surface lighting, bitmaps, color palettes, and/or the like, to generate a visible 3-D surface of a character after the rendering process is complete. As earlier discussed, this mesh may be referred to as a controller.

The 3-D animation may be based on a plurality of keys depicting the 3-D object. The 3-D animation may also be associated with an animation timeline defined by two endpoints—a starting time point and an ending time point. Using set keys, the user who is working with the 3-D animation may manipulate the object forward and backward along the animation timeline, between the starting time point and the ending time point, by selecting (e.g., clicking on) and moving (e.g., dragging) any of the controllers of the object as shown on the display screen. The user may use any of the controllers as a scroll/slide button to move the animation forward and backward along the animation timeline.

As discussed earlier, a user animates an object via keys. A key can be manipulated by the user in various ways: cut; copied and pasted; cut, copied, and pasted; deleted; scaled; snapped in time to the nearest whole time unit value or attribute value; baked (i.e., keys are created on every frame, so that the user can edit the individual keys, and adjust the animation); muted; edited, and the like.

The key monitoring module 150 may check for the manipulation of a key by a user. When the key monitoring module 150 determines that a key is being manipulated, the key monitoring module 150 may determine how the key is being manipulated (e.g., deleted, moved, scaled, and the like) by the user.

The key monitoring module 150 may determine the identity of a controller that is currently selected by the user. In order to determine the controller that is currently selected by the user, the key monitoring module 150 may check for a controller that is named based on a rigging name convention. For instance, the rigging name convention may be set as follows: c_sideOfBody_name_versionNumber_type. Using this example, if a character has four arms (with two arms on each side), the selected elbow controller on the lower arm of the right side would be named “c_R_elbow_v2_CTRL,” per the rigging name convention. The “v2” stands for “version 2,” which is to be understood as the second limb of the right side, and “CTRL” would stand for “controller.” The manipulation of the key corresponds to a position change of the selected controller. The key monitoring module 150 may disable the position monitoring module 160 in order to avoid a double calculation with regard to the position change. The key monitoring module 150 may collect the position data of that selected controller to determine the new position of the selected controller caused by the manipulation of the key.

The key monitoring module 150 may find the controllers related to the selected controller and loop through all the related controllers that are found. The selected controller has a string attribute that has been placed by the user either manually or automatically through a script. The controllers related to the selected controller have this string attribute as well. The key monitoring module 150 finds the controllers related to the selected controller by searching the controllers for this string attribute that was placed on the selected controller. Using the collected position data of the selected controller, the key monitoring module 150 may apply the position change of the selected controller (i.e., the change from the previous position to the new position of the selected controller) to the related controllers.

The selection monitoring module 155 may check for a mode selection for a selected controller by a user. When the selection monitoring module 155 determines that a mode selection has been made, the selection monitoring module 155 may determine what the selected mode is (e.g., whether the controller has been set to either global mode or local mode). In order to determine the controller that is currently selected by the user, the selection monitoring module 155 may check for a controller that is named based on a rigging name convention. For instance, the rigging name convention may be set as follows: c_sideOfBody_name_versionNumber_type. Using this example, if a character has four arms (with two arms on each side), the selected elbow controller on the lower arm of the right side would be named “c_R_elbow_v2_CTRL,” per the rigging name convention. The “v2” stands for “version 2,” which is to be understood as the second limb of the right side, and “CTRL” would stand for “controller.”

The selection monitoring module 155 may then find the controllers related to the selected controller and loop through all the related controllers that are found. The selected controller has a string attribute that has been placed by the user either manually or automatically through a script. The controllers related to the selected controller have this string attribute as well. The selection monitoring module 155 finds the controllers related to the selected controller by searching the controllers for this string attribute that was placed on the selected controller. The selection monitoring module 155 may then apply the selected mode to the related controllers.

The position monitoring module 160 may check for a change in a position of a selected controller. In order to determine the controller that is currently selected by the user, the position monitoring module 160 may check for a controller that is named based on a rigging name convention. For instance, the rigging name convention may be set as follows: c_sideOfBody_name_versionNumber_type. Using this example, if a character has four arms (with two arms on each side), the selected elbow controller on the lower arm of the right side would be named “c_R_elbow_v2_CTRL,” per the rigging name convention. The “v2” stands for “version 2,” which is to be understood as the second limb of the right side, and “CTRL” would stand for “controller.” If the change in a position of the selected controller is keyed, the key monitoring module 150 may be the module that works to apply the new position of the selected controller to the related controllers of the selected controllers. If the change in a position of the selected control is not keyed, the position monitoring module 160 may become involved. When the position monitoring module 160 determines that a position change (that has not been keyed) has been made for a selected controller, the position monitoring module 160 may collect the position data of the selected controller. The position monitoring module 160 may store the collected position data of the selected controller in a variable, in which a variable is a storage container that stores data.

A change in a position of a selected controller is keyed when a timestamp is placed on an attribute of a node. For instance, using the 3-D coordinates of the 3-D computing environment, the user may move a cube up on the “y” (elevation) axis by 10 units. The user may then set a key on the cube at a frame 5. In this example, the position of the cube (moved up 10 units on the “y” axis) has been keyed at frame 5.

The position monitoring module 160 may find the controllers related to the selected controller and loop through all the related controllers that are found. The selected controller has a string attribute that has been placed by the user either manually or automatically through a script. The controllers related to the selected controller have this string attribute as well. The position monitoring module 160 finds the controllers related to the selected controller by searching the controllers for this string attribute that was placed on the selected controller. The position monitoring module 160 may then apply the position change of the selected controller to the related controllers.

In some embodiments, logic 135 may include a color key module, which is another module that improves the experience of a user in the rigging of a character in a 3-D environment. As discussed earlier, the timeline displays keys of a controller that has been selected by the user. In some cases, the user may select more than one controller. When this happens, the keys of the controllers are all displayed on the timeline, and there is no distinction between keys that are associated with different controllers. The color key module provides a solution to this problem by assigning a first color to a first controller. The keys that are associated with the first controller are assigned the first color. The color key module may assign a second color to a second controller. The keys that are associated with the second controller are assigned the second color, and so on. In a non-limiting example, a user may select two controllers, and the keys associated with the two controllers are displayed on the timeline.

In other embodiments, logic 135 may include a IK/FK guide module, which is a module that also improves the experience of a user in character rigging.

In addition to using solely FK or IK to pose and animate appendage joints, a user can blend FK and IK animation on the same joints. This may be known as “animation blending” or “IK/FK blending.” IK/FK blending between IK and FK animation allows a user to switch between posing and animating with pure FK or pure IK, as well as to control the blend between the two kinds of animation. In IK/FK blending, a first set of controllers is set for IK mode and a second set of controllers is set for FK mode.

As discussed earlier, in IK/FK blending, a first group of controllers is set in IK mode and a second group of controllers is set in FK mode. For instance, if a user is working in IK mode, the controllers set in IK mode are visible and the controllers set in FK mode are invisible. The IK/FK guide module provides a solution to this problem by allowing the controller(s) set in the unused mode to be visible but unable to be selected by the user until the user switches to the mode of the controller(s). In the previous example with the user working in IK mode, the controllers set in IK mode and the controllers set in FK mode are both visible. However, the user is not able to select the controllers set in FK mode until the user works in FK mode. The IK/FK guide module determines the current mode (IK or FK) in which the user is working. The IK/FK guide module may then identify the controller(s) that is/are set in the current mode and may render them both visible and selectable. The IK/FK guide module may then render the controller(s) that is/are not set in the current mode as visible but unselectable.

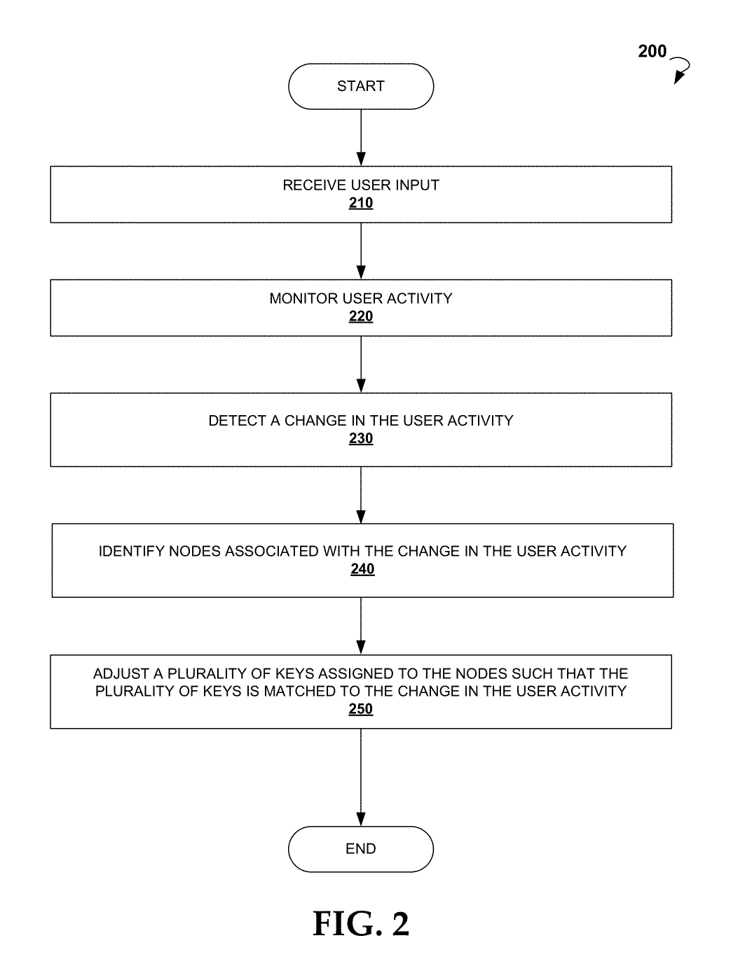

FIG. 2 is a flow chart showing an exemplary method 200 for monitoring animation curve data and managing controllers in a 3-D computer environment, according to embodiments of the present disclosure. Method 200 can be performed by processing logic that includes hardware (e.g., decision-making logic, dedicated logic, programmable logic, application-specific integrated circuit), software (such as software run on a general-purpose computer system or dedicated machine), or a combination of both. In one example embodiment, the processing logic refers to one or more elements the systems shown in FIG. 1.

Operations of method 200 recited below can be implemented in an order different than described and shown in FIG. 2. Moreover, the method 200 may have additional operations not shown herein, but which can be evident to those skilled in the art from the present disclosure. Method 200 may also have fewer operations than shown in FIG. 2 and described below.

The method 200 may commence in operation 210 with receiving user input, for example, in the form of user activity in the rigging of a character. The receipt of user input may trigger the monitoring of the user activity in the rigging of a character.

Operation 220 includes monitoring the user activity, the user activity indicated by a change in animation curve data. Any change to the data in an animation curve is indicative of the user activity that is being monitored.

The method 200 may proceed in operation 230 with detecting a change in the user activity. The change may be associated with at least one of the following actions by a user in rigging the character: utilizing a tool, manipulating a key, selecting a mode for a selected controller, and changing a position of a selected controller.

Operation 240 may include identifying nodes associated with the change in the user activity. As discussed earlier, nodes may be controllers that are manipulated by the user in the rigging of a character.

At operation 250, a plurality of keys assigned to the identified nodes is adjusted such that the plurality of keys is matched to the change in the user activity. In an example, when the detected change in user activity is the user utilizing a tool, operation 250 may further comprise: determining that a tool is currently used by the user; determining a node of the identified nodes that is currently selected by the user; setting the currently selected node to a kinematic mode that is appropriate with respect to the currently used tool; finding nodes related to the currently selected node; and setting the related nodes to the kinematic mode that is appropriate with respect to the currently used tool.

In another example, when the detected change in user activity is the user manipulating a key, operation 250 may further comprise: determining a node of the identified nodes that is currently selected by the user; detecting a manipulation of a key by the user, in which the manipulation of the key corresponds to a position change of the currently selected node; collecting position data of the selected node; using the collected position data, determining a new position of the selected node corresponding to the manipulation of the key; finding nodes related to the currently selected node; and applying the position change of the selected node (i.e., the change from the previous position to the new position of the selected node) to the related nodes.

In yet another example, when the detected change in user activity is the user selecting a mode for a selected node, operation 250 may further comprise: determining a node of the identified nodes that is currently selected by the user; determining a mode of the currently selected node; finding nodes related to the currently selected node; and setting the related nodes to the mode of the currently selected node.

In an example, when the detected change in user activity is the user changing a position of a selected node, operation 250 may further comprise: determining a node of the identified nodes that is currently selected by the user; detecting a position change of the currently selected node; collecting position data of the selected node; using the collected position data, determining a new position of the selected node corresponding to the position change; finding nodes related to the currently selected node; and applying the position change of the selected node (i.e., the change from the previous position to the new position of the selected node) to the related nodes.

Method 200 may further comprise: tracking the positions of all controllers under the inactive kinematic mode and the currently active kinematic mode, and updating the positions of the controllers under the inactive kinematic mode to match the positions of the controllers under the currently active kinematic mode.

In another example, method 200 may further comprise: assigning a first color to a first node; assigning the first color to a first set of keys that are associated with the first node; assigning a second color to a second node; and assigning the second color to a second set of keys that are associated with the second node.

In yet another example, method 200 may further comprise: identifying a first mode in which the user is currently working, the first mode being either IK mode or FK mode; finding nodes set in the first mode; allowing the nodes set in the first mode to be visible and selectable by the user while the user is in the first mode; identifying a second mode in which the user is currently not working, the second mode being either IK mode if the first mode is FK mode, or the second mode being FK mode if the first mode is IK mode; and allowing the nodes set in the second mode to be visible and unselectable by the user while the user is in the first mode.

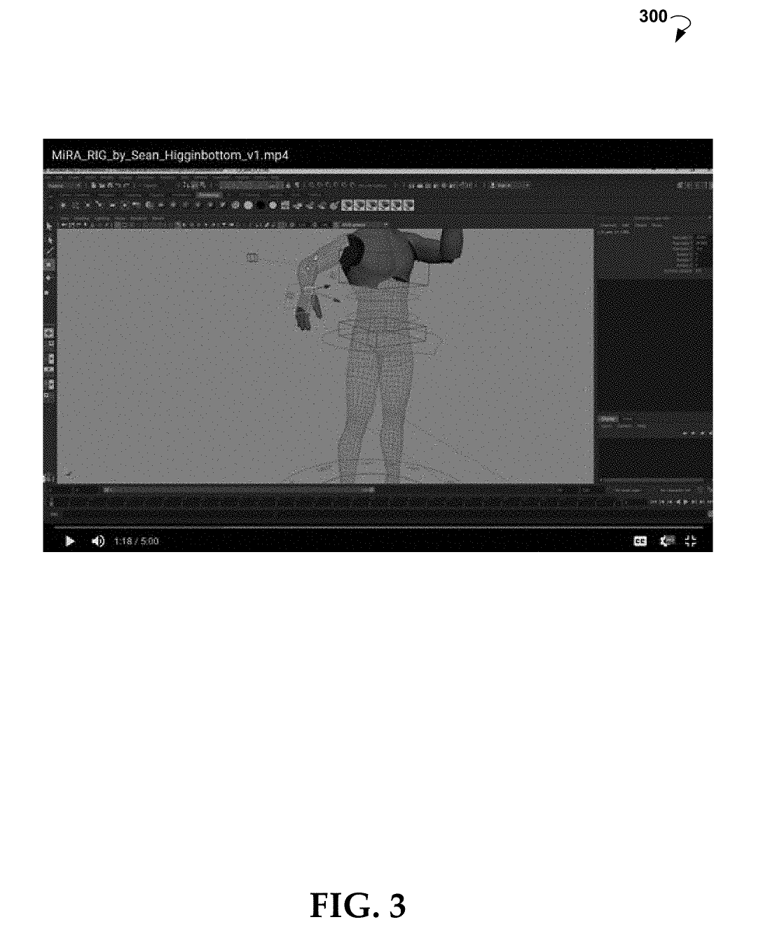

FIG. 3 is a screenshot that illustrates the rigging of a character in a 3-D environment 300 in which the method described in the present disclosure are utilized.

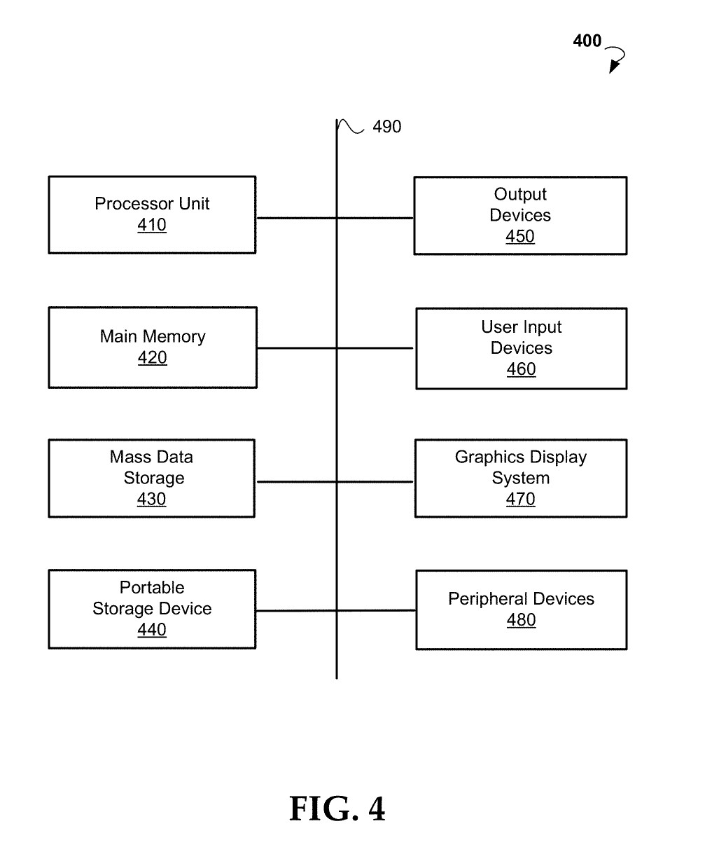

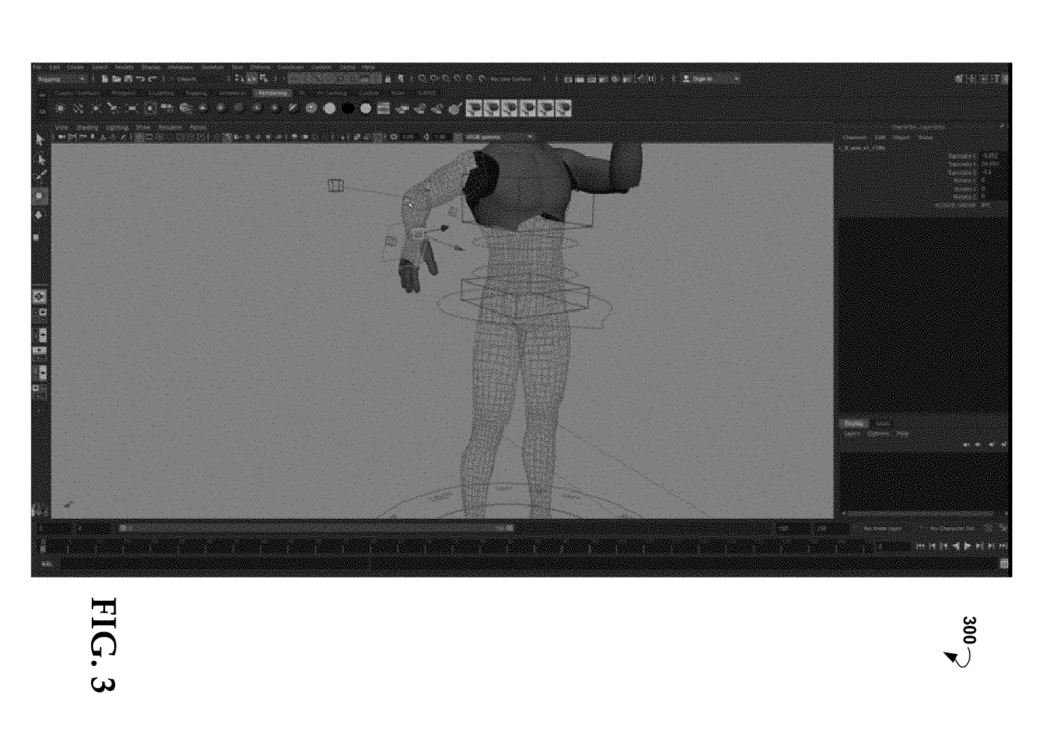

FIG. 4 illustrates an exemplary computer system 400 that may be used to implement some embodiments of the present technology. Computer system 400 may be implemented in the contexts of the likes of computing systems such as server system 110 and client 105. Computer system 400 includes one or more processor units 410 and main memory 420. Main memory 420 stores, in part, instructions and data for execution by processor units 410. Main memory 420 stores the executable code when in operation, in this example. Computer system 400 further includes a mass data storage 430, portable storage device 440, output devices 450, user input devices 460, a graphics display system 470, and peripheral devices 480.

The components shown in FIG. 4 are depicted as being connected via a single bus 490. The components may be connected through one or more data transport means. Processor unit 410 and main memory 420 is connected via a local microprocessor bus, and the mass data storage 430, peripheral device(s) 480, portable storage device 440, and graphics display system 470 are connected via one or more input/output (I/O) buses.

Mass data storage 430, which can be implemented with a magnetic disk drive, solid state drive, or an optical disk drive, is a non-volatile storage device for storing data and instructions for use by processor unit 410. Mass data storage 430 stores the system software for implementing embodiments of the present disclosure for purposes of loading that software into main memory 420.

Portable storage device 440 operates in conjunction with a portable non-volatile storage medium, such as a flash drive, floppy disk, compact disk, digital video disc, or USB storage device, to input and output data and code to and from computer system 400. The system software for implementing embodiments of the present disclosure is stored on such a portable medium and input to computer system 400 via portable storage device 440.

User input devices 460 can provide a portion of a user interface. User input devices 460 may include one or more microphones, an alphanumeric keypad, such as a keyboard, for inputting alphanumeric and other information, or a pointing device, such as a mouse, a trackball, stylus, or cursor direction keys. User input devices 460 can also include a touchscreen. Additionally, computer system 400 includes output devices 450. Suitable output devices 450 include speakers, printers, network interfaces, and monitors.

Graphics display system 470 include a liquid crystal display (LCD) or other suitable display device. Graphics display system 470 is configurable to receive textual and graphical information and processes the information for output to the display device. Peripheral devices 480 may include any type of computer support device to add additional functionality to the computer system.

The components provided in computer system 400 are those typically found in computer systems that may be suitable for use with embodiments of the present disclosure and are intended to represent a broad category of such computer components that are well known in the art. Thus, computer system 400 can be a personal computer (PC), hand held computer system, telephone, mobile computer system, workstation, tablet computer, mobile phone, server, minicomputer, mainframe computer, wearable computer, or any other computing system. The computer may also include different bus configurations, networked platforms, multi-processor platforms, and the like.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, computing system 400 may be implemented as a cloud-based computing environment, such as a virtual machine operating within a computing cloud. In other embodiments, computing system 400 may itself include a cloud-based computing environment, where the functionalities of the computing system 400 are executed in a distributed fashion. Thus, computing system 400, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as computing device 400, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1. A computer-implemented method for monitoring user activity and managing controllers in a 3-D environment, the method comprising:
receiving user input in the form of user activity associated with a rigging of a character in a 3-D environment;
monitoring the user activity, the user activity being indicated by a change in animation curve data;
detecting a change in the user activity, wherein the change in the user activity comprises the user utilizing a tool, the user manipulating a key, the user selecting a mode for a selected node, or the user changing a position of a selected node;
identifying nodes associated with the change in the user activity, in which the nodes are controllers that are manipulated by the user in the rigging of a character in a 3-D environment;
adjusting the nodes such that the nodes are matched to the change in the user activity wherein a currently selected node in the identified nodes has a string attribute that has been placed by the user either manually or automatically through a script; other nodes related to the currently selected node have this string attribute; the other nodes related to the currently selected node are found by searching for this string attribute that was placed on the currently selected node;
tracking positions of controllers under an inactive kinematic mode and positions of controllers under a currently active kinematic mode;
updating the positions of the controllers under the inactive kinematic mode to match the positions of the controllers under the currently active kinematic mode; and
eliminating a change in a position and/or pose of an appendage of a character that is caused by the switching between inverse kinematics and forward kinematics during the course of animation to position and/or pose an appendage of a character.

2. The method of claim 1, in which the detected change in user activity is the user utilizing a tool, and in which the step of identifying nodes associated with the change in the user activity and adjusting the nodes comprise:
determining that a tool is currently used by the user;
determining a node of the identified nodes that is currently selected by the user;
setting the currently selected node to a kinematic mode that is appropriate with respect to the currently used tool;
finding nodes related to the currently selected node; and
setting the related nodes to the kinematic mode that is appropriate with respect to the currently used tool.

3. The method of claim 1, in which the detected change in user activity is the user manipulating a key, and in which the step of identifying nodes associated with the change in the user activity and adjusting the nodes comprise:
determining a node of the identified nodes that is currently selected by the user;
detecting a manipulation of a key by the user, in which the manipulation of the key corresponds to a position change of the currently selected node;
collecting position data of the selected node;
using the collected position data, determining a new position of the selected node corresponding to the manipulation of the key;
finding nodes related to the currently selected node; and
applying the position change of the selected node to the related nodes.

4. The method of claim 1, in which the detected change in user activity is the user selecting a mode for a selected node, and in which the step of identifying nodes associated with the change in the user activity and adjusting the nodes comprise:
determining a node of the identified nodes that is currently selected by the user;
determining a mode of the currently selected node;
finding nodes related to the currently selected node; and
setting the related nodes to the mode of the currently selected node.

5. The method of claim 1, in which the detected change in user activity is the user changing a position of a selected node, and in which the step of identifying nodes associated with the change in the user activity and adjusting the nodes comprise:
determining a node of the identified nodes that is currently selected by the user;
detecting a position change of the currently selected node;
collecting position data of the selected node;
using the collected position data, determining a new position of the selected node corresponding to the position change;
finding nodes related to the currently selected node; and
applying the position change of the selected node to the related nodes.

6. (canceled)

7. The method of claim 1, in which the method further includes:
assigning a first color to a first node;
assigning the first color to a first set of keys that are associated with the first node;
assigning a second color to a second node; and
assigning the second color to a second set of keys that are associated with the second node.

8. The method of claim 1, in which the method further includes:
identifying a first mode in which the user is currently working, the first mode being either an inverse kinematic mode or a forward kinematic mode;
finding nodes set in the first mode;
configuring the nodes set in the first mode to be visible and selectable by the user while the user is in the first mode;
identifying a second mode in which the user is currently not working, the second mode being either the inverse kinematic mode if the first mode is the forward kinematic mode, or the second mode being the forward kinematic mode if the first mode is the inverse kinematic mode; and
configuring the nodes set in the second mode to be visible and unselectable by the user while the user is in the first mode.

9. A system comprising:
a processor; and
a memory coupled to the processor, the memory storing instructions executable by the processor to perform a method for monitoring user activity and managing controllers in a 3-D environment comprising:
monitoring user activity associated with a rigging of a character in a 3-D environment, the user activity being indicated by a change in animation curve data;
detecting a change in the user activity, wherein the change in the user activity comprises the user utilizing a tool, the user manipulating a key, the user selecting a mode for a selected node, or the user changing a position of a selected node;
identifying nodes associated with the change in the user activity in which the nodes are controllers that are manipulated by a user in the rigging of a character in a 3D environment;
adjusting the nodes such that the nodes are matched to the change in the user activity wherein a currently selected node in the identified nodes has a string attribute that has been placed by the user either manually or automatically through a script; other nodes related to the currently selected node have this string attribute; the other nodes related to the currently selected node are found by searching for this string attribute that was placed on the currently selected node;
tracking positions of controllers under an inactive kinematic mode and positions of controllers under a currently active kinematic mode;
updating the positions of the controllers under the inactive kinematic mode to match the positions of the controllers under the currently active kinematic mode; and
eliminating a change in a position and/or pose of an appendage of a character that is caused by the switching between inverse kinematics and forward kinematics during the course of animation to position and/or pose an appendage of a character.

10. The system of claim 9, in which the detected change in user activity is the user utilizing a tool, and in which identifying nodes associated with the change in the user activity and adjusting the nodes comprises:
determining that a tool is currently used by the user;
determining a node of the identified nodes that is currently selected by the user;
setting the currently selected node to a kinematic mode that is appropriate with respect to the currently used tool;
finding nodes related to the currently selected node; and
setting the related nodes to the kinematic mode that is appropriate with respect to the currently used tool.

11. The system of claim 9, in which the detected change in user activity is the user manipulating a key, and in which identifying nodes associated with the change in the user activity and adjusting the nodes comprises:
determining a node of the identified nodes that is currently selected by the user;
detecting a manipulation of a key by the user, in which the manipulation of the key corresponds to a position change of the currently selected node;
collecting position data of the selected node;
using the collected position data, determining a new position of the selected node corresponding to the manipulation of the key;
finding nodes related to the currently selected node; and
applying the position change of the selected node to the related nodes.

12. The system of claim 9, in which the detected change in user activity is the user selecting a mode for a selected node, and in identifying nodes associated with the change in the user activity and adjusting the nodes comprises:
determining a node of the identified nodes that is currently selected by the user;
determining a mode of the currently selected node;
finding nodes related to the currently selected node; and
setting the related nodes to the mode of the currently selected node.

13. The system of claim 9, in which the detected change in user activity is the user changing a position of a selected node, and in which identifying nodes associated with the change in the user activity and adjusting the nodes comprises:
determining a node of the identified nodes that is currently selected by the user;
detecting a position change of the currently selected node;
collecting position data of the selected node;
using the collected position data, determining a new position of the selected node corresponding to the position change;
finding nodes related to the currently selected node; and
applying the position change of the selected node to the related nodes.

14. (canceled)

15. The system of claim 9, in which the method performed by the system further includes:
assigning a first color to a first node;
assigning the first color to a first set of keys that are associated with the first node;
assigning a second color to a second node; and
assigning the second color to a second set of keys that are associated with the second node.

16. The system of claim 9, in which the method performed by the system further includes:
identifying a first mode in which the user is currently working, the first mode being either an inverse kinematic or a forward kinematic mode;
finding nodes set in the first mode;
configuring the nodes set in the first mode to be visible and selectable by the user while the user is in the first mode;
identifying a second mode in which the user is currently not working, the second mode being either the inverse kinematic mode if the first mode is the forward kinematic mode, or the second mode being the forward kinematic mode if the first mode is the inverse kinematic mode; and
configuring the nodes set in the second mode to be visible and unselectable by the user while the user is in the first mode.

17. A non-transitory computer-readable storage medium having stored thereon computer-executable instructions that, in response to execution by a processor, performs the computer-implemented method for monitoring user activity and managing controllers in a 3-D environment, the method comprising:
receiving user input in the form of user activity associated with a rigging of a character in a 3-D environment;
monitoring the user activity, the user activity being indicated by a change in animation curve data;
detecting a change in the user activity, wherein the change in the user activity comprises the user utilizing a tool, the user manipulating a key, the user selecting a mode for a selected node, or the user changing a position of a selected node;
identifying nodes associated with the change in the user activity, in which the nodes are controllers that are manipulated by the user in the rigging of a character in a 3-D environment;
adjusting the nodes such that the nodes are matched to the change in the user activity wherein a currently selected node in the identified nodes has a string attribute that has been placed by the user either manually or automatically through a script; other nodes related to the currently selected node have this string attribute; the other nodes related to the currently selected node are found by searching for this string attribute that was placed on the currently selected node;
tracking positions of controllers under an inactive kinematic mode and positions of controllers under a currently active kinematic mode;
updating the positions of the controllers under the inactive kinematic mode to match the positions of the controllers under the currently active kinematic mode; and
eliminating a change in a position and/or pose of an appendage of a character that is caused by the switching between inverse kinematics and forward kinematics during the course of animation to position and/or pose an appendage of a character.
